(19) United States
(12) Patent Application Publication
(10) Pub. No.: US 2025/0077258 A1
(43) Pub. Date: Mar. 6, 2025

(54) CREDIT ALLOCATION FOR ENABLING ACCESS TO HARDWARE RESOURCES OF A COMPUTING DEVICE

(71) Applicant: Western Digital Technologies, Inc., San Jose, CA (US)

(72) Inventors: Vineeth Saseendran, Bangalore (IN); Sathyanarayanan Subramanian, Bangalore (IN); Jatin Gaur, Bangalore (IN)

(21) Appl. No.: 18/461,089

(22) Filed: Sep. 5, 2023

(51) Int. Cl. G06F 9/455

(52) U.S. Cl. CPC G06F 9/45558; G06F 2009/45583

(57) ABSTRACT

A computing device hosts a number of virtual machines and each virtual machine executes one or more applications. The computing device also includes a credit allocation system that allocates credits to the various applications. The allocated credits provide each application access to various hardware resources of the computing device and help ensure each application has access to the various hardware resources of the computing device.

### BACKGROUND

Virtualization enables physical hardware of a computing device, known as the host computing device, to be divided into multiple virtual computers or virtual machines (VMs). Each VM can execute applications, store data and perform various other tasks.

Each VM hosted by the host computing device shares the hardware resources of the host computing device. For example, each VM hosted by the host computing device share the same data storage device. However, each VM (or each application executed by each VM) may be configured to perform specific tasks and each task may have different data storage requirements. For example, one VM may need to quickly and efficiently store small (or large) amounts of data in a cache associated with the data storage device while another VM may need to periodically storage large amounts of data in the cache. Because each VM has access to the same cache, scenarios may arise in which one VM cannot access or store data in the cache because the cache has reached capacity due to other VMs accessing and storing data in the cache.

Accordingly, it would be beneficial for a host computing device to control access to various hardware resources that are shared among different VMs.

### SUMMARY

The present application describes a credit allocation scheme for controlling access to various hardware/physical resources of a computing device. In an example, the credit allocation scheme is used or implemented by a computing device that hosts a number of virtual machines (VMs). Each VM may execute one or more applications and each application may be executed to perform specific tasks. As such, each application may have different hardware resource requirements.

The computing device may use the credit allocation scheme to allocate credits to each VM (or application) to help ensure each VM has access to the various physical resources of the computing device. For example, the computing device may determine the capabilities of a particular hardware resource (e.g., storage capacity of a cache of a data storage device) and determine the resource requirements of the VM (e.g., what hardware resources the VM needs to accomplish one or more tasks). Based on this information, the computing device allocates a particular number of credits to the VM. Credits are consumed when the VM accesses or uses the hardware resource. Credits may subsequently be released back to the VM as the computing device executes other operations (e.g., garbage collection operations).

Accordingly, examples of the present disclosure describe a method that includes receiving cache information associated with a cache of a data storage device and determining a functionality of an application associated with a virtual machine. Credits are allocated to the application based, at least in part, on the determined functionality of the application and the cache information. In an example, the credits provide the application access to the cache.

The present disclosure also describes a system that includes a processor and a memory communicatively coupled to the processor. The memory stores instructions that, when executed by the processor, perform operations including receiving information associated a data storage device and determining, based at least in part, on the information, a number of credits available for allocation. In an example, the credits provide access to a cache of the data storage device. The operations also include determining a functionality of an application. The operations also include determining a number of credits to be allocated to the application. In an example, this determination is based, at least in part, on the determined functionality of the application and on the number of credits available for allocation. The determined number of credits may then be allocated to the application.

The present application also describes a system that includes a credit allocation means. In an example, the credit allocation means includes a physical resource capability determination means and an application functionality determination means. In an example, the physical resource capability determination means determines a capability of a physical resource associated with the system and the application functionality determination means determines a functionality of an application associated with the system. The credit allocation means allocates one or more credits to the application based, at least in part, on the determined capability of the physical resource and on the functionality of the application. In an example, the one or more credits provide the application access to the physical resource.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that may be used to execute the various processes described herein according to an example.

FIG. 2 illustrates a system that includes a host device that hosts a plurality of virtual machines according to an example.

FIG. 3 illustrates a method for allocating credits to a virtual machine according to an example.

FIG. 4 illustrates a method for determining whether an application may access a hardware resource of a host device according to an example.

FIG. 5 illustrates a method for releasing credits according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

Virtualization enables hardware resources of a computing device to be divided into multiple virtual computers or virtual machines (VMs). Each VM hosted by the host computing device can perform the same or similar functions as the host computing device. For example, a VM can have an operating system, execute applications, store data and perform various other tasks.

However, as previously explained, each VM shares the hardware resources of the host computing device. Thus, as various applications are executed by each VM, the applications compete for the hardware resources of the host computing device. For example, each application may compete for storage space in a cache of a data storage device. Further, each application may have different storage needs.

For example, a first VM (or application) may need to frequently store a small amount of data in the cache while a second VM (or application) may need to frequently store large amounts of data in the cache. However, because each VM has unrestricted access to the cache, the first VM may not be able to access the cache because the second VM has caused the cache to reach capacity.

In order to address the above, the present application describes a credit allocation scheme for controlling access to various hardware resources of a computing device. In the examples that follow, a cache of a data storage device is the hardware resource for which credits are allocated. However, it is contemplated that the credit allocation scheme may be used to allocate credits for a number of different hardware resources of a computing device.

Additionally, the examples described herein discuss allocating credits to various applications being executed by a VM. However, it should be understood that the credit allocation scheme may be used to allocate credits to various applications that are being executed by the host device.

As will be explained in greater detail herein, the credit allocation scheme may be used or implemented by a computing device that hosts a number of VMs. Each VM may execute one or more applications and each application may be executed to perform different tasks. As such, each application may have different hardware resource requirements.

The computing device may use the credit allocation scheme to allocate credits to each VM (or application) to help ensure each VM has access to the various hardware resources of the computing device. For example, the computing device may determine the capabilities of a particular hardware resource (e.g., storage capacity of a cache of a data storage device) and determine the resource requirements of the VM (e.g., what resources the VM needs to accomplish one or more tasks).

Based on this information, the computing device allocates a particular number of credits to the VM. Credits are consumed when the VM accesses or uses the hardware resource. Thus, if a particular VM has not been allocated any credits or does not have a sufficient amount (or any) allocated credits remaining, the VM cannot access the particular hardware resource. Credits may subsequently be released back to the VM as the computing device executes other operations (e.g., garbage collection operations).

Accordingly, many technical benefits may be realized including, but not limited to, ensuring that each application has sufficient resources to accomplish its assigned task(s) by controlling access to various hardware resources, enabling the efficient sharing of hardware resources, and enabling the allocation of hardware resources based on a determined need.

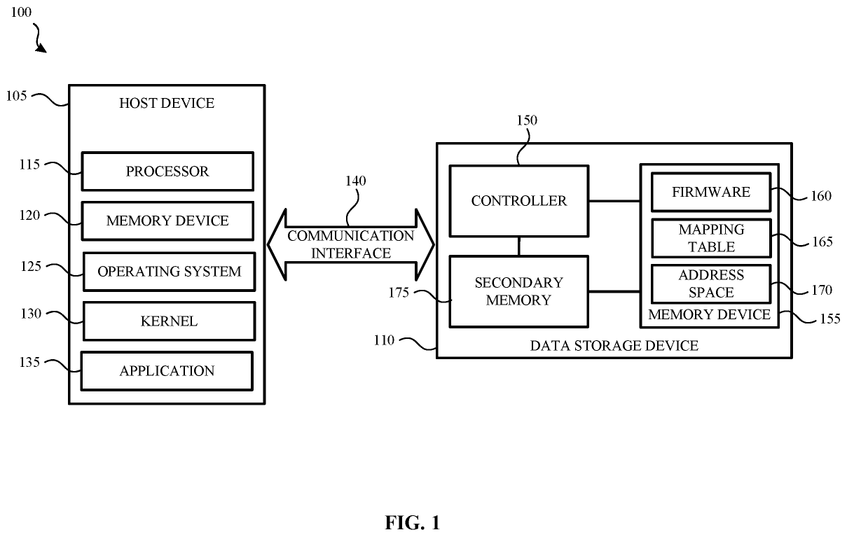

These benefits and other examples will be shown and described in greater detail with respect to FIG. 1-FIG. 5.

FIG. 1 is a block diagram of a system 100 that includes a host device 105 and a data storage device 110 according to an example. In an example, the host device 105 includes a processor 115 and a memory device 120 (e.g., main memory). The memory device 120 may include or otherwise be associated with an operating system 125, a kernel 130 and/or an application 135.

The processor 115 can execute various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 may include a System on a Chip (SoC). Although a single processor 115 (or SoC) is shown and described, the host device 105 may include many processors and/or SoCs.

In an example, the memory device 120 stores data used by the processor 115. Data stored in the memory device 120 may include instructions provided by/to the data storage device 110 via a communication interface 140. The data stored in the memory device 120 may also include data used to execute instructions from the operating system 125 and/or one or more applications 135. In an example, the memory 120 is volatile memory, such as, for example, Dynamic Random Access Memory (DRAM).

In an example, the operating system 125 may create a virtual address space for the application 135 and/or other processes executed by the processor 115. The virtual address space may map to locations in the memory device 120. The operating system 125 may include or otherwise be associated with a kernel 130. The kernel 130 may include instructions for managing various resources of the host device 105 (e.g., memory allocation), handling read and write requests and so on.

The operating system 125 may also enable the creation and/or execution of one or more VMs. For example, the host device 105 may host various VMs. Each VM may act independently and be associated with the same processor 115 (or SoC) or different processors 115 (or SoCs). Further, each VM may be configured to execute one or more applications. In an example, each VM and each application may require access to various physical resources associated with the host device 105.

In an example, each VM may have access to various physical resources associated with the host device 105 using a virtual function (VF). In an example, a VF includes an identifier and is assigned to a particular VM. The VF enables the logical separation of the various physical resources of the host device 105 and also enables the VM to access the physical resources.

The VF may also be associated with a secondary controller. Like the VF, each secondary controller functions independently of the other secondary controllers associated with the host device 105. Further, each secondary controller may be associated with one or more namespaces. In an example, the namespace is associated or otherwise identifies a logical isolation/division of a portion of a physical resource (e.g., the data storage device 110).

As will be explained in greater detail, the host device 105 may allocate or apportion credits to various VMs based on a functionality of each VM and/or characteristics of the physical resources associated with the host device. The credits enable each VM to access/use various physical resources of the host device 105.

In an example, allocation of credits to a VM includes allocation of credits to a VF associated with the VM, to an application (or applications or sub-applications) executed by the VM, to one or more namespaces associated with the VM and/or to a secondary controller associated with the VM.

The host device 105 and the data storage device 110 are communicatively coupled by a communication interface 140. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or WiFi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as, but not limited to, Non-Volatile Memory express (NVMe), Universal Flash Storage (UFS) or Advanced Host Controller Interface (AHCI).

The data storage device 110 may implement a Zoned Namespace (ZNS) storage architecture. As such, the data storage device 110 may be divided into multiple zones with each zone containing a contiguous range of logical block addresses (LBAs). In such an example, the host device 105 may be required to write data to the data storage device 110 in a sequential manner.

The data storage device 110 includes a controller 150 and a memory device 155 (e.g. volatile and/or non-volatile memory). The memory device 155 (and/or portions of the memory device 155) may also be referred to as a storage medium. The memory device 155 includes a number of storage elements. In an example, each storage element is a chip or a memory die that is used to store data.

For example, the memory device 155 may include a first memory die and a second memory die. In an example, the first memory die and the second memory die include non-volatile memory elements such as, for example, NAND flash memory elements and/or NOR flash memory elements. Although two memory dies are mentioned, the memory device 155 may include any number of storage elements. For example, the storage elements may take the form of solid-state memory such as, for example, 2D NAND, 3D NAND memory, multi-level cell memory, triple level cell memory, quad-level cell memory, penta-level cell memory or any combination thereof. Additionally, each memory die may be divided into one or more zones. As indicated above, a zone is a contiguous range of LBAs that may store data.

The controller 150 may include circuitry for executing instructions. The instructions may originate from firmware 160 associated with the data storage device 110. In another example, the instructions may originate from the host device 105. Accordingly, the controller 150 may include circuitry such as one or more processors, a microcontroller, a DSP, an ASIC, an FPGA, hard-wired logic, analog circuitry and/or a combination thereof. In another example, the controller 150 may include a SoC or multiple SoCs.

The data storage device 110 may also include secondary memory 175. The secondary memory 175 may be a rotating magnetic disk or non-volatile solid-state memory, such as flash memory. While the description herein refers to solid-state memory generally, it is understood that solid-state memory may comprise one or more of various types of memory devices such as flash integrated circuits, NAND memory (e.g., single-level cell (SLC) memory, multi-level cell (MLC) memory (i.e., two or more levels), or any combination thereof), NOR memory, EEPROM, other discrete Non-Volatile Memory (NVM) chips, or any combination thereof.

In some examples, the memory device 155 is capable of storing data at a byte-addressable level, as opposed to other types of non-volatile memory that have a smallest writable data size such as a page size of 4 KB or a sector size of 512 Bytes.

In an example, the memory device 155 may also store a mapping table 165 and/or an address space 170. In some examples, the controller 150 can associate portions of data stored in the secondary memory 175 with unique identifiers. The unique identifiers may be stored in the memory device 155 and be used by the operating system 125 to access stored data. For example, the mapping table 165 can provide a mapping of unique identifiers with indications of physical locations (e.g., Physical Block Addresses (PBAs)) where the corresponding portions of data are stored in the memory device 155 and/or the secondary memory 175.

In some examples, the firmware 160 may store, maintain, be associated with or otherwise have access to a mapping table (e.g., mapping table 165) that stores and/or maintains the updated programming order of memory dies for specific memory blocks.

As briefly discussed above, the memory device 155 may also include address space 170. The address space 170 can serve as at least a portion of an address space used by the processor 115. In an example, the address space 170 can store data at a byte-addressable level that can be accessed by the processor 115 (e.g., via the communication interface 140).

For example, the data storage device 110 may provide the host device 105 with an indication of the address space 170. The host device 105 may then associate an address range for the address space 170 and an indication that this address range is to be used as a byte-addressable address space, such as for a page cache.

In another example, the host device 105 may manage the data storage device 110 such that the processor 115 can directly access address space 170. For example, the data storage device 110 may provide logical to physical address translation information to the host device 105, which can be called by the host device 105 and executed by the processor 115 and/or the controller 150. In some examples, the controller 150 may include or otherwise be associated with a flash translation layer (FTL). The FTL may map the logical block addresses to the physical addresses of the memory device 155.

Although FIG. 1 illustrates the host device 105 being separate from the data storage device 110, the host device 105 and the data storage device 110, as well the various components described, may be part of a single device or part of multiple devices.

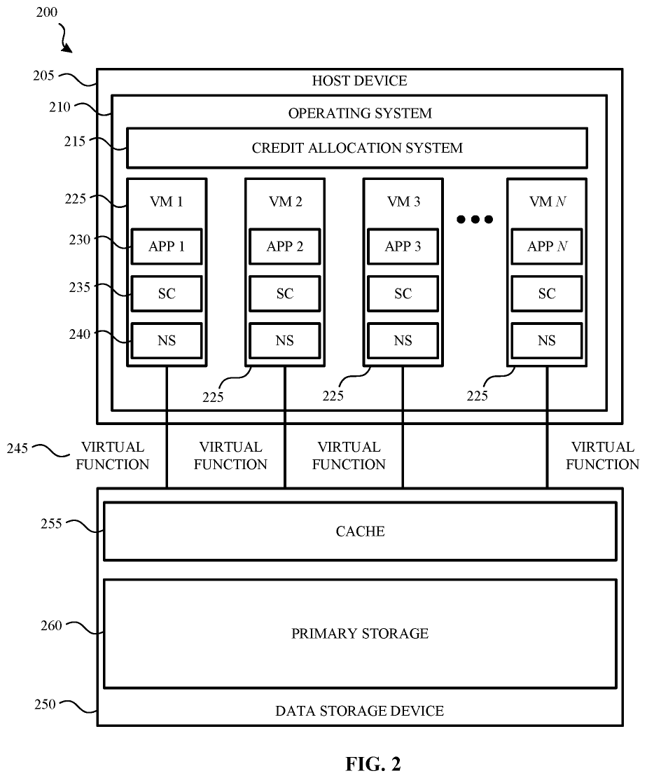

FIG. 2 illustrates a system 200 that includes a host device 205 that hosts a plurality of virtual machines (VMs) according to an example. In an example, the host device 205 is similar to the host device 105 shown and described with respect to FIG. 1.

The host device 205 includes an operating system 210. In an example, the operating system 210 supports the creation and/or hosting of a number of different VMs. For example, the operating system 210 of the host device 205 includes N VMs 225 (e.g., VM 1, VM 2, VM 3 . . . . VM N). Additionally, each VM 225 is associated with or otherwise executes an application 230 (e.g., App 1, App 2, App 3 . . . . App N). In an example, each application 230 may be executed to accomplish a particular function or task and may require the use of various hardware resources of the host device 205.

Each VM 225 may also be associated with a secondary controller 235. Each secondary controller 235 may function independently of the other secondary controllers 235 associated with each VM 225. Further, each secondary controller 235 may be associated with one or more namespaces 240. In an example, a namespace 240 may indicate or specify a logical isolation/division of a portion of a hardware resource of the host device 205.

In an example, each secondary controller 235 and/or each VM 225 may be assigned or otherwise associated with a virtual function 245. Each virtual function 245 may be associated with an identifier and provide a logical interface to a hardware resource associated with the host device 205. For example, the virtual function 245 may provide VM 1 access to the data storage device 250.

The operating system 210 may also include otherwise be associated with a credit allocation system 215. In an example, the credit allocation system 215 is responsible for allocating credits to, or otherwise associating credits with, each of the VMs 225, one or more of the applications 230 being executed by each VM 225, one or more namespaces 240 associated with each VM 225, a secondary controller 235 associated with each VM 225 and/or the virtual function 245 associated with each VM 225.

In an example, the credits enable each VM 225 to access one or more hardware resources of the host device 205. Further, and as will be explained in greater detail herein, the number of credits that are allocated may be based, at least in part, on the functionality of the VM 225 (e.g., a functionality of an application 230 or applications/sub-applications being executed by the VM 225) and/or the capabilities of the hardware resource of the host device 205.

In the examples that follow, the physical resource of the host device 205 for which credits are allocated is a data storage device 250. In an example, the data storage device 250 may be similar to the data storage device 110 shown and described with respect to FIG. 1. Although a data storage device 250 is specifically mentioned, the credit allocation system may be used to provide credits for access to various hardware resources.

The data storage device 250 may include a cache 255 and a primary storage 260. In an example, the cache 255 is a single-level cell (SLC) cache and the primary storage 260 is triple-level cell (TLC) storage. In an example, each VM 225 may access the cache 255 and/or the primary storage 260 via its respective virtual function 245 and/or secondary controller 235.

However, as previously explained, in current implementations (e.g., implementations that do not include a credit allocation system 215), each application 230 and/or VM 225 may have unrestricted access to the cache 225 and may store any amount of data in the cache 255 at any time. This may cause problems for the system 200 as some applications 230 may need to store data in cache 255 more frequently than others and may not be able to store data in the cache 255 because the cache is at capacity.

For example, the system 200 may be used in an automotive application. Although an automotive application is specifically mentioned, this is for example purposes only. In this example, each VM 225 may have a specific task to perform with respect to a vehicle. For example, VM 1 may be in charge of some or all of the sensing operations (e.g., camera/sensor application(s), self-driving application(s)) of the vehicle, VM 2 may be in charge of the infotainment operations (e.g., a map application including generating routes and/or updating/refreshing the map on a display) of the vehicle and VM 3 may be in charge of remote connectivity of the vehicle.

Each VM 225 and its associated application 230 may have different storage needs with respect to the cache 255. For example, VM 1 may need to periodically, but quickly, store a lot of data (e.g., 1 GB) in the cache 255. However, VM 2 may need to frequently store small amounts of data in cache 255. In current implementations (e.g., implementations that do not include a credit allocation system 215), VM 2 may monopolize use of the cache 255. Thus, when VM 1 needs to access the cache 255 to store data, there may not be sufficient room in the cache 255. As such, the overall performance of the system 200 may be negatively impacted. Further, VM 3 may not need to store data in the cache 255. However, in current implementations, VM 3 may also store data in the cache 255 due to the speed at which data is stored in the cache 255.

The credit allocation system 215 resolves these issues. As previously explained, the credit allocation system 215 determines the needs/functionality of each VM 225 and/or application 230 and allocates credits to the VM 225, the application 230, the secondary controller 245 and/or one or more namespaces 240 associated with each VM 225 based, at least in part, on the determined needs/functionality. The credits provide access to the cache 255.

The credit allocation system 215 also determines the capabilities of the hardware resource of the host device 205. The number of credits that are allocated to each VM 225 may also be based on the determined capabilities of the hardware resource. For example, the credit allocation system 215 may determine a capacity of the cache 255 and determine, based on the capacity, the total number of credits that may be allocated.

Additionally, the credit allocation system may determine a size of each credit. In an example, each credit may represent 4 kilobytes (KB) of storage in the cache 255. Although 4 KB is specifically mentioned, each credit may represent anywhere from 512 bytes to 128 KB of storage in the cache 255. Thus, if each credit is 4 KB and the capacity of the cache 255 is 10 GB, the credit allocation system 215 may allocate a total of 2,500,000 credits. As previously discussed, the credit allocation system 215 may then allocate any number of credits to each VM 225 and/or application 230.

For example, the credit allocation system 215 may allocate 1,500,000 credits to VM 1, allocate 500,000 credits to VM 2, zero credits to VM 3 and 500,000 to VM N. Further, each of the credits that are allocated to a particular VM 225 may be sub-divided and/or sub-allocated to various sub-applications. In another example, the credits may be allocated to one or more namespaces 240 and/or secondary controllers 235 associated with each application 230 and VM 225.

As previously discussed, the credits enable the VM 225 to access the cache 255. Thus, if VM 1 issues a write command, the credit allocation system 215 determines: 1) whether VM 1 has been allocated credits; 2) the amount of storage in the cache 255 that is required to satisfy the write command; and 3) whether VM 1 has enough credits to cover or otherwise account for the amount of storage space in the cache 255 that will be consumed/taken as a result of the write command.

If the credit allocation system 215 determines that VM 1 has been issued credits and that VM 1 has a sufficient amount of remaining credits, the credit allocation system 215 provides VM 1 access to the cache 255. When access to the cache 255 has been granted, the credit allocation system 215 consumes the credits (e.g., the credits are no longer useable by VM 1) that were used to access the cache 255. During a background operation (e.g., a garbage collection operation and/or when data is transferred from the cache 255 to the primary storage 260) the consumed credits may be returned to VM 1.

However, if the credit allocation system 215 determines that VM 1 has not been issued credits or that VM 1 does not have a sufficient amount of credits remaining, the credit allocation system 215 causes VM 1 to store data in primary storage 260.

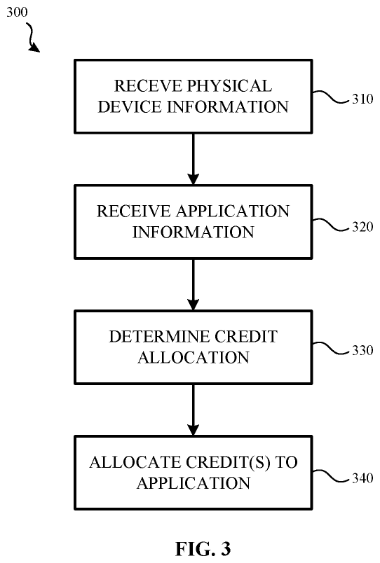

FIG. 3 illustrates a method 300 for allocating credits to a VM according to an example. In an example, the method 300 may be executed or performed by a credit allocation system of a host device such as, for example, the credit allocation system 215 of the host device 205 shown and described with respect to FIG. 2.

In an example, the method 300 begins when the credit allocation system receives (310) information about a physical device (e.g., a hardware resource) of a computing device. The information may include capabilities of the physical device. For example, if the physical device is a data storage device, the information may include a capacity of a cache of the data storage device.

The credit allocation system may also receive (320) information about a particular application being executed on or by the computing device. In an example, the application may be executed by the computing device. In another example, the application may be executed by a VM that is hosted by the computing device. In yet another example, the application may include one or more sub-applications.

The information about the application may include information about one or more tasks the application is to accomplish, an indication of which physical device(s) the application needs to access, a frequency at which the application will use the physical device(s) and so on. The information may also include a priority of the application with respect to other applications that are executed by the computing device and/or each VM. For example, the sensing application of the automobile example previously described may have a higher priority than the infotainment application. Thus, the sensing application may be given a higher priority than the infotainment application.

Based on receiving the physical device information and the application information, the credit allocation system determines (330) a number of credits that can be allocated to, or otherwise associated with, each application. As explained above, the amount of credits may be based on the priority of the application, the functionality of the application and so on.

In an example, the credit allocation system may also determine a size of each credit. For example, the credit allocation system may determine that each credit represents 4 kilobytes (KB) of storage in a cache of a data storage device. Therefore, if each credit is 4 KB and the capacity of the cache is 10 GB, the credit allocation system may allocate a total of 2,500,000 credits. In another example, each credit may represent anywhere from 512 bytes to 128 KB of storage in the cache. Therefore, the credit allocation system will allocate an amount of credits based, at least in part on the size of the cache and the size of each credit.

Once the number of credits available for allocation is determined, the credit allocation system allocates (340) credits to the various VMs/applications. For example and based on the number of available credits and on the application information, the credit allocation system may allocate 1,000,000 credits to a first VM/application, 500,000 to a second VM/application, 500,000 to a third VM/application, 250,000 to a fourth VM/application and 250,000 to a fifth VM/application.

It is contemplated that some VMs/applications may not receive any credits during the allocation process. Further, it is contemplated that the credit allocation may be dynamically adjusted. For example, the allocation of credits may be adjusted as new features/updates are added to or removed from each application and/or VM and/or as new VMs/applications are hosted by the computing device.

While the examples described with respect to FIG. 3 indicate that credits are allocation to a VM or an application, the credits may also be allocated to a secondary controller and/or one or more namespaces associated with the VM. In another example, credits may be allocated to various sub-applications of a particular application. For example, if an application was allocated 500,000 credits, 100,000 credits may be allocated to a first sub-application and 200,000 credits may be allocated to another sub-application while the remaining 200,000 credits are allocated to the application itself.

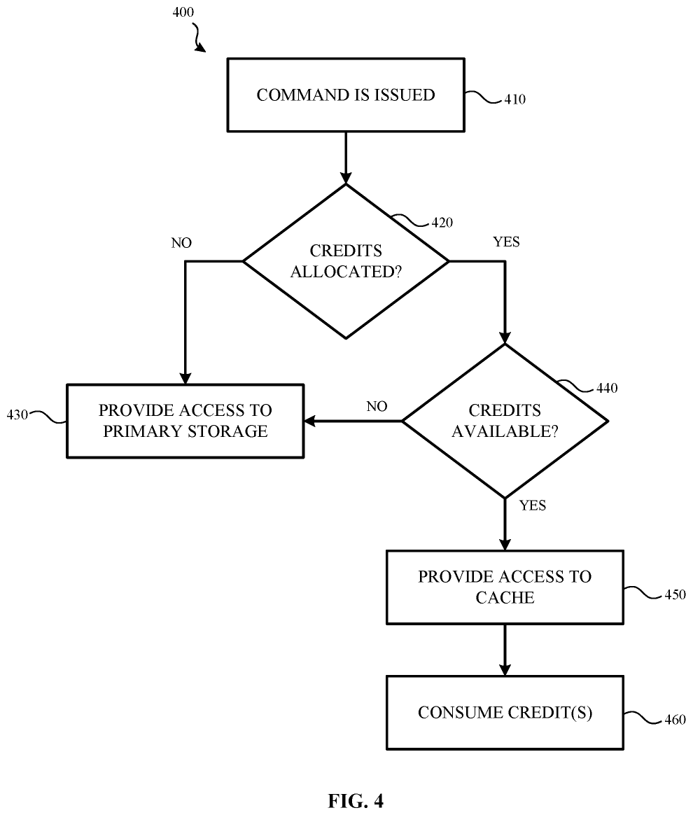

FIG. 4 illustrates a method 400 for determining whether an application may access a hardware resource of a host device according to an example. In an example, the method 400 may be performed by a credit allocation system of a host device such as, for example, the credit allocation system 215 of the host device 205 shown and described with respect to FIG. 2.

Method 400 begins when a command is issued (410). In an example, the command that is issued by may be a request to access a hardware resource of the host device. For example, the issued command may be a write command in which data is to be written to a data storage device and is issued from an application associated with a VM. In an example, an operating system of the host device and/or the credit allocation system of the host device may monitor issued commands and/or receive issued commands and subsequently determine whether the hardware resource may be accessed and/or the manner/duration in which the hardware resource may be accessed.

When the command is issued and/or received, the credit allocation system determines (420) whether the VM/application has been issued credits associated with the hardware resource. In the examples that follow, the hardware resource is a data storage device that includes a cache and primary storage. Additionally, the issued command may be a request to access the cache of the data storage device.

Continuing with the example, above, when the command is issued by the VM/application, the credit allocation system may determine whether the particular VM/application was allocated any credits associated with the data storage device. If it is determined that the VM/application was not issued any credits, the credit allocation system provides (430) the VM/application access to the primary storage of the data storage device. The data may then be written to primary storage.

However, if it is determined that the VM/application was allocated credits, the credit allocation system determines whether the particular VM/application has credits available (440). For example, the credit allocation system determines whether the VM/application has consumed and/all of its credit and/or whether the VM/application has a sufficient amount of credits to satisfy the write command.

If it is determined that the VM/application does not have a sufficient amount of credits available, the credit allocation system provides (430) the VM/application access to the primary storage of the data storage device.

For example, the write command may be a command to write 1 GB of data in the cache and the VM/application may have been issued 500,000 credits, with each credit representing 4 KB of storage in the cache. However, the VM/application may have already consumed 400,000 credits and only has 100,000 credits remaining. In this example, execution of the write command requires 250,000 credits. Because the VM/application does not have 250,000 credits available, the credit allocation system will provide the VM/application access to the primary storage of the data storage device.

However, if it is determined (440) that the VM/application has a sufficient amount of credits available, the credit allocation system provides (450) the VM/application access to the cache of the data storage device. Once access has been provided, the credit allocation system consumes (460) the credits associated with the VM/application.

For example, the write command may be a command to write 1 GB of data in the cache and the VM/application may have been issued 500,000 credits, with each credit representing 4 KB of storage in the cache. However, in this example, the VM/application may have already consumed 100,000 credits and has 400,000 credits remaining. As with the previous example, execution of the write command requires 250,000 credits. Because the VM/application has 400,000 credits available, the credit allocation system will provide the VM/application access to the cache of the data storage device and consume 250,000 credits. As a result, the VM/application will have 150,000 credits remaining.

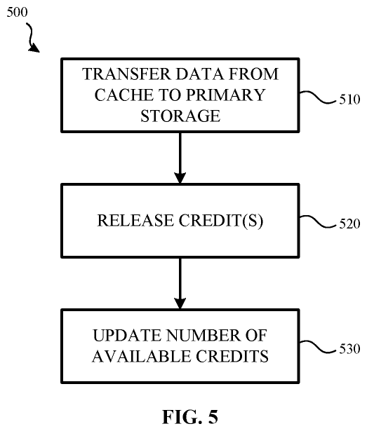

FIG. 5 illustrates a method 500 for releasing credits according to an example. In an example, the method 500 may be performed by a credit allocation system of a host device such as, for example, the credit allocation system 215 of the host device 205 shown and described with respect to FIG. 2.

In an example, method 500 begins during a background operation (e.g., a garbage collection operation and/or a data transfer operation) of a data storage device. For example, method 500 begins when data is transferred (510) from a cache of a data storage device to primary storage of the data storage device.

As data is being transferred from the cache to primary storage, the credit allocation system may track or otherwise determine which data is being written to primary storage and from which VM/application the data originated.

As data is being transferred to the primary storage, the credit allocation system may release (520) consumed credits (e.g., the credits are made available to the VM/application to which they were originally allocated). The credit allocation system may also update (530) the number of available credits associated with each VM/application.

Based on the above, examples of the present disclosure describe a method, comprising: receiving cache information associated with a cache of a data storage device; determining a functionality of an application associated with a virtual machine; and based, at least in part, on the determined functionality of the application and the cache information, allocating credits for the application, the credits providing access to the cache. In an example, the method also includes receiving a data storage device access request from the application; determining whether the application has available credits; and based on determining the application has available credits, providing the application access to the cache. In an example, the method also includes determining an amount of credits associated with the data storage device access request. In an example, the method also includes consuming the amount of credits based, at least in part, on providing the application access to the cache. In an example, the method also includes releasing the amount of credits that were consumed based, at least in part, on transferring data from the cache to primary storage of the data storage device. In an example, each credit represents an amount of storage in the cache. In an example, the amount of storage is between 512 bytes and 128 kilobytes (KB). In an example, the application is associated with a plurality of sub-applications and wherein allocating credits for the application includes sub-allocating credits to each of the plurality of sub-applications. In an example, the cache is a single-level cell cache.

Examples also describe a system, comprising: a processor; and a memory communicatively coupled to the processor and storing instructions that, when executed by the processor, perform operations, comprising: receiving information associated a data storage device; determining, based at least in part, on the information, a number of credits available for allocation, the credits providing access to a cache of the data storage device; determining a functionality of an application; determining a number of credits to be allocated to the application based, at least in part, on the determined functionality of the application and on the number of credits available for allocation; and allocating the determined number of credits to the application. In an example, the application is associated with a virtual machine. In an example, the instructions include instructions for: determining whether the application has available credits based, at least in part, on receiving a data storage device access request from the application; and based on determining the application has available credits, providing the application access to the cache. In an example, the instructions include instructions for determining an amount of credits associated with the data storage device access request. In an example, the instructions include instructions for consuming the amount of credits from the allocated determined number of credits based, at least in part, on providing the application access to the cache. In an example, the instructions include instructions for releasing the amount of credits that were consumed, wherein the amount of credits that were consumed are released during a garbage collection process. In an example, each credit represents an amount of storage in the cache. In an example, the amount of storage is between 512 bytes and 128 kilobytes (KB).

Examples also describe a system, comprising: a credit allocation means, comprising: a physical resource capability determination means that determines a capability of a physical resource associated with the system; and an application functionality determination means that determines a functionality of an application associated with the system, wherein the credit allocation means allocates one or more credits to the application based, at least in part, on the determined capability of the physical resource and on the functionality of the application, wherein the one or more credits provide the application access to the physical resource. In an example, the application is executed by a virtual machine. In an example, the credit allocation means tracks an amount of credits consumed by the application as the application accesses the physical resource.

The term computer-readable media as used herein may include computer storage media. Computer storage media may include volatile and nonvolatile, removable and non-removable media implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by a computing device (e.g., host device 105 (FIG. 1)). Any such computer storage media may be part of the computing device. Computer storage media does not include a carrier wave or other propagated or modulated data signal.

Additionally, examples described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various examples.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method, comprising:
receiving cache information associated with a cache of a data storage device;
determining a functionality of an application associated with a virtual machine; and
based, at least in part, on the determined functionality of the application and the cache information, allocating credits for the application, the credits providing access to the cache.

2. The method of claim 1, further comprising:
receiving a data storage device access request from the application;
determining whether the application has available credits; and
based on determining the application has available credits, providing the application access to the cache.

3. The method of claim 2, further comprising determining an amount of credits associated with the data storage device access request.

4. The method of claim 3, further comprising consuming the amount of credits based, at least in part, on providing the application access to the cache.

5. The method of claim 4, further comprising releasing the amount of credits that were consumed based, at least in part, on transferring data from the cache to primary storage of the data storage device.

6. The method of claim 1, wherein each credit represents an amount of storage in the cache.

7. The method of claim 6, wherein the amount of storage is between 512 bytes and 128 kilobytes (KB).

8. The method of claim 1, wherein the application is associated with a plurality of sub-applications and wherein allocating credits for the application includes sub-allocating credits to each of the plurality of sub-applications.

9. The method of claim 1, wherein the cache is a single-level cell cache.

10. A system, comprising:
a processor; and
a memory communicatively coupled to the processor and storing instructions that, when executed by the processor, perform operations, comprising:
receiving information associated a data storage device;
determining, based at least in part, on the information, a number of credits available for allocation, the credits providing access to a cache of the data storage device;
determining a functionality of an application;
determining a number of credits to be allocated to the application based, at least in part, on the determined functionality of the application and on the number of credits available for allocation; and
allocating the determined number of credits to the application.

11. The system of claim 10, wherein the application is associated with a virtual machine.

12. The system of claim 10, further comprising instructions for:
determining whether the application has available credits based, at least in part, on receiving a data storage device access request from the application; and
based on determining the application has available credits, providing the application access to the cache.

13. The system of claim 12, further comprising instructions for determining an amount of credits associated with the data storage device access request.

14. The system of claim 13, further comprising instructions for consuming the amount of credits from the allocated determined number of credits based, at least in part, on providing the application access to the cache.

15. The system of claim 14, further comprising instructions for releasing the amount of credits that were consumed, wherein the amount of credits that were consumed are released during a garbage collection process.

16. The system of claim 10, wherein each credit represents an amount of storage in the cache.

17. The system of claim 16, wherein the amount of storage is between 512 bytes and 128 kilobytes (KB).

18. A system, comprising:
a credit allocation means, comprising:
a physical resource capability determination means that determines a capability of a physical resource associated with the system; and
an application functionality determination means that determines a functionality of an application associated with the system, wherein the credit allocation means allocates one or more credits to the application based, at least in part, on the determined capability of the physical resource and on the functionality of the application, wherein the one or more credits provide the application access to the physical resource.

19. The system of claim 18, wherein the application is executed by a virtual machine.

20. The system of claim 18, wherein the credit allocation means tracks an amount of credits consumed by the application as the application accesses the physical resource.
